(19) United States
(12) Patent Application Publication
(10) Pub. No.: US 2013/0195049 A1
(43) Pub. Date: Aug. 1, 2013

(54) Radio Resource Control Connection Release For User Devices Out Of Up Link Time Alignment

(71) Applicants: Yang Yang, Morris Plains, NJ (US); Ling Ding, Chester, NJ (US)

(72) Inventors: Yang Yang, Morris Plains, NJ (US); Ling Ding, Chester, NJ (US)

(21) Appl. No.: 13/753,048

(22) Filed: Jan. 29, 2013

Related U.S. Application Data
(60) Provisional application No. 61/591,994, filed on Jan. 29, 2012.

(51) Int. Cl. H04W 72/04

(52) U.S. Cl. CPC H04W 72/04
USPC 370/329

(57) ABSTRACT

An example wireless communication system includes a wireless access device and a wireless access point. The wireless access device is configured to receive a radio resource control connection release message while in a non-time aligned state, the non-time aligned state being characterized by a lack of up link channel control by the wireless access device. The wireless access point is configured to transmit the radio resource control connection release message when the wireless access point determines that a radio resource control connection to the wireless access device should be released and the wireless access device is in the non-time aligned state.

### RELATED APPLICATIONS

This application claims priority pursuant to 35 U.S.C. Sec 119(e) to U.S. Provisional Application No. 61/591,994, filed Jan. 29, 2012, entitled “Radio Resource Control Connection Release For User Devices Out Of Up Link Time Alignment,” the subject matter thereof being fully incorporated herein by reference.

### FIELD OF THE INVENTION

The invention generally relates to data transmission in a wireless communications system.

### BACKGROUND INFORMATION

In wireless communications systems applying Long Term Evolution (LTE) protocols and standards, the mobile unit, or User Equipment (UE) operates on one of two states relative to the radio interface maintained with a serving base station, or enhanced Node B (eNB). Those states are designated RRC_Connected and RRC_Idle (RRC indicating “Radio Resource Control”). In the RRC_Connected state, the UE maintains an active connection with the eNB, while in the RRC_Idle state, no connection exists between the UE and the eNB, with the UE waking up (e.g., turning on its receiver) at defined intervals to listen for pages from an eNB. As will be apparent, battery resources in the UE and radio frequency (RF) resources in the cell in which the UE is operating will be much more heavily consumed in the RRC_Connected state than in the RRC_Idle state (and, as well, intra-cell and inter-cell interference associated with the maintenance of an active connection between the UE and eNB will be largely absent in the RRC_Idle state).

In LTE, a RRC_Connected UE must maintain Up Link (UL) time alignment with an eNB in order to perform data communication. If the UE has no data to transmit or receive for a period of time (e.g, a predetermined period of time, a long time, a certain amount of minutes or other time unit, etc), there is no need to maintain the UL time alignment. The lack of maintenance of the UL time alignment can save both Down Link (DL) radio resource, for example command messages such as the Periodic Time Alignment Command sent from the eNB to the UE and the like, etc, or other command messages, and UL radio resource, such as UL control channels. The UE can remain in RRC_Connected state without time alignment.

FIG. 1 illustrates a schematic depiction of a conventional prior art message call flow for a UE resulting in the entry of an Out-Of-Time-Alignment state while remaining in the RRC_Connected state. At 110, the RRC-Connected UE receives a Time Alignment message from the eNB. The RRC_Connected UE must maintain Up Link (UL) time alignment with an eNB in order to perform data communication. At 120, the RRC-Connected UE once again receives a Time Alignment message from the eNB. A Time Alignment message is sent from the eNB to the UE from time to time in order that the UE maintain time alignment with the eNB and maintain up link channel control. At 130, a Timer Alignment Timer in the UE expires, as a threshold period of time from the last receipt of the Time Alignment message has passed. From this moment on, the UE releases the Layer 1 control channel resource and the UE enters an Out-Of-Time-Alignment state. After 130, a period of time as expired since the eNB has received an uplink from the UE such that the eNB has not sent another Time Alignment message thereby permitting the UE to remain in the RRC_Connected state but enter an Out of Uplink Time Alignment state.

If at some later time, while in the RRC_Connected state and Out of Uplink Time Alignment state, the UE has data to transmit or receive, the UE can quickly re-obtain UL time alignment and resume data communication by performing a LTE Random Access Channel (RACH) procedure which indicates the UE's desire to establish an active connection. The above described is more cost effective than moving the UE to the RRC_Idle state, from which the UE has to perform a RRC connection setup process before data traffic can start.

The described procedure of putting a traffic inactive UE in an out-of-time-alignment state provides an efficient and attractive method to retain large number of UEs in the RRC_connected state without demanding large amount of UL control channel resources.

### SUMMARY OF THE INFORMATION

Placing a traffic inactive UE in the out-of-time-alignment state produces detrimental effects when an eNB wants to release the UE to the RRC_Idle state. While a traffic inactive UE may be maintained in the RRC_Connected state without demanding large amount of UL control channel resources, this procedure becomes ineffective when (i.e., in the event that) the eNB wants to release the out-of-time-alignment UE to the RRC_Idle state. In that event, the eNB has to ask the UE to RACH (i.e., perform the RACH procedure) and regain the UL Layer 1 configurations only to send a RRC release message to let the UE release the connection.

FIG. 2 illustrates a schematic depiction of a prior art message call flow for a UE resulting in the exit of an Out-Of-Time-Alignment state while continuing to remain in the RRC_Connected state. At 210, the eNB sends (or the UE receives) a Physical Downlink Control Channel (PDCCH) Order to ask the UE to RACH and regain the UL Layer 1 configurations. At 220, the UE sends (or the eNB receives) a RACH.

At 230, the eNB sends a RACH Response. At 240, the UE send a RACH msg 3. (Without being stated throughout the specification, it is abundantly clear that as the eNb sends, the UE receives on the other side of the communication, and visa versa.)

At 250, the eNB sends a RRC Reconfiguration Physical Uplink Control Channel/Sounding Reference Signal (PUCCH/SRS). At this point, the UE regains L1 control channel resource. At 260, the UE send a RRC Reconfiguration Complete message. From this moment on, data traffic is permitted to resume between the UE and the eNB. However in the event that the eNB wants to release the out-of-time-alignment UE to the RRC_Idle state, such steps have been taken only for the eNB to send a RRC release message to let UE release the connection. Accordingly, this message call flow has been undertaken with the purpose to release the RRC connection including all radio bearers and all signaling radio bearers between the UE and the eNB.

All of the detailed connection setup and release steps are well known in the art, and need not be further described here. It should be readily apparent, however, from this brief description of the conventional connection setup and release process that, when the cell has large number of such out-of-time-alignment users, this RRC release process produces high RF and signaling overhead as explained above. Consequently, the above described process does not result in the efficient utilization of wireless system resources.

Accordingly, system, method and apparatus embodiments are provide herein to promote efficient utilization of wireless system resources.

An example wireless communication system comprises a wireless access device, the wireless access device configured to receive a radio resource control connection release message while in a non-time aligned state, the non-time aligned state characterized by a lack of up link channel control by the wireless access device; and a wireless access point, the wireless access point configured to transmit the radio resource control connection release message when the wireless access point determines that a radio resource control connection to the wireless access device should be released and the wireless access device is in the non-time aligned state.

In one embodiment, the wireless access device is configured to enter the non-time aligned state in response to the expiry of a time alignment timer.

In one embodiment, the wireless access device is configured to release layer 1 control channel resource in response to entry into the non-time aligned state.

In one embodiment, the wireless access device is configured to release the radio resource control connection in response to receipt of the radio resource control connection release message while in the non-time aligned state.

In one embodiment, wherein the wireless access device is configured to enter an idle state in response to receipt of the radio resource control connection release message while in the non-time aligned state.

In one embodiment, the wireless access device is a user equipment and wherein the wireless access point is a base station, a Node B, and enhanced Node B.

In one embodiment, the wireless access point is configured to determine that the radio resource control connection to the wireless access device should be released based on passage of a first period of time without data channel traffic with the wireless access device.

In one embodiment, the wireless access point is configured to determine that the wireless access device is in the non-time aligned state based on passage of a second period of time with a lack of data channel traffic with the wireless access device, and wherein the first period of time is greater than the second period of time.

In one embodiment, the wireless access point is configured to determine that the wireless access device is in the non-time aligned state based on passage of a second period of time without data channel traffic with the wireless access device.

In one embodiment, the wireless access point is configured to end or preclude transmission of time alignment messages to the wireless device when the wireless access point determines the wireless access device is in the non-time aligned state.

In another embodiment, an apparatus comprising a processor and an associated memory, wherein the processor is configured to receive a radio resource control connection release message while in a non-time aligned state, the non-time aligned stated characterized by a lack of up link channel control by the apparatus.

In one embodiment, the processor is configured to enter the non-time aligned state and release layer 1 control channel resource in response to expiry of a time alignment timer. In one embodiment, the processor is configured to release the radio resource control connection in response to receipt of the radio resource control connection release message while in the non-time aligned state.

In one embodiment, the processor is configured to enter the non-time aligned state in response to the expiry of a time alignment timer. In one embodiment, the processor is configured to release layer 1 control channel resource in response to entry into the non-time aligned state.

In one embodiment, the processor is configured to process the radio resource control connection release message in response to receipt of the radio resource control connection release message. In one embodiment, the processor is configured to enter an idle state in response to receipt of the radio resource control connection release message while in the non-time aligned state. In one embodiment, the apparatus is a user equipment, a mobile, mobile device, a mobile station, an electronic device having wireless communication capabilities, a cellular phone, a personal digital assistant (PDA), a smartphone, a laptop computer or an electronic device capable of changing its point of attachment from one network or subnetwork to another.

In another embodiment, an apparatus comprises a processor and an associated memory, wherein the processor is configured to transmit a radio resource control connection release message in response to determining that a radio resource control connection to a wireless access device should be released and the wireless access device is in a non-time aligned state, the non-time aligned state characterized by a lack of data channel traffic with the wireless access device.

In one embodiment, the processor is configured to determine that the radio resource control connection to the wireless access device should be released based on passage of a first period of time without data channel traffic with the wireless access device. In one embodiment, the processor is configured to determine that the wireless access device is in the non-time aligned state based on passage of a second period of time with a lack of data channel traffic with the wireless access device. In one embodiment, the first period of time is greater than the second period of time. In one embodiment, the radio resource control connection release message includes an indicator for instructing the wireless access device that the radio resource control connection release message is not be responded to.

In one embodiment, the processor is configured to end or preclude transmission of time alignment messages for the wireless access device when the processor determines that the wireless access device is in the non-time aligned state. In one embodiment, the apparatus is a base station, a Node B, and enhanced Node B.

In another embodiment, a management element for a wireless communication system comprises a processor configured for determining whether a wireless access device is in a non-time aligned state, and determining whether a radio resource control connection to the wireless access device should be released, and instructing transmission of at least one radio resource control connection release message to the wireless access device for releasing a radio resource control connection when determining both that the wireless access device is in a non-time aligned state and a radio resource control connection to the wireless access device should be released, the transmission of the at least one radio resource control connection release message performed without first instructing transmission of control messages for enabling the wireless access device to regain layer 1 control channel resource.

Reference herein to “one embodiment”, “another embodiment”, “an exemplary embodiment” and “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. Although various embodiments which incorporate the teachings of the present invention have been shown and described in detail herein, those skilled in the art can readily devise many other varied embodiments that still incorporate these teachings.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present invention, and wherein:

FIG. 1 illustrates a schematic depiction of a conventional prior art message call flow for a UE resulting in the entry of an Out-Of-Time-Alignment state while remaining in the RRC_Connected state;

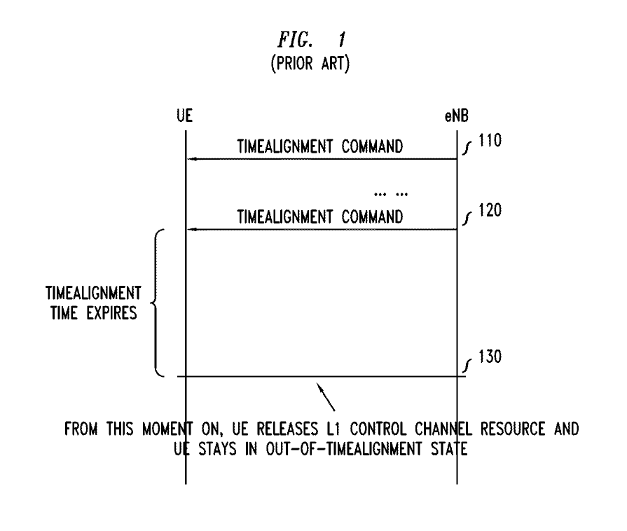

FIG. 2 illustrates a schematic depiction of a prior art message call flow for a UE resulting in the exit of an Out-Of-Time-Alignment state while continuing to remain in the RRC_Connected state;

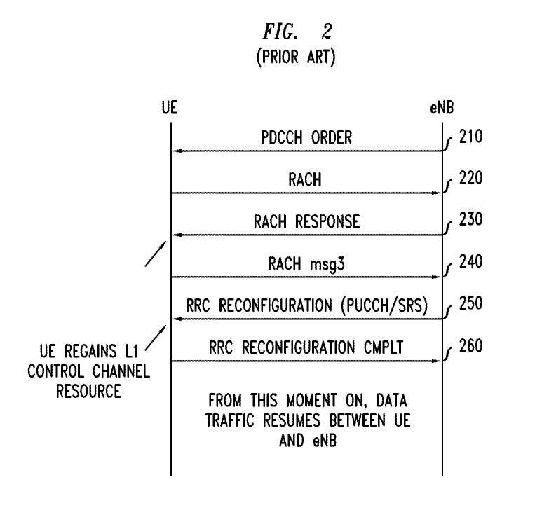

FIG. 3 illustrates a schematic depiction of an example message call flow for a UE resulting in the fast release of an Out-of-Time-Alignment UE in RRC_Connected State in accord with the principles of the invention;

FIG. 4 illustrates an example flow diagram illustrating activity at a UE in accord with the principles of the invention;

FIG. 5 illustrates an example flow diagram illustrating activity at an eNB in accord with the principles of the invention; and

FIG. 6 illustrates a high-level block diagram of an example computer for implementing a UE or eNB in accord with the principles of the invention.

### DETAILED DESCRIPTION

Various example embodiments will now be described more fully with reference to the accompanying figures, it being noted that specific structural and functional details disclosed herein are merely representative for purposes of describing example embodiments. Example embodiments may be embodied in many alternate forms and should not be construed as limited to only the embodiments set forth herein.

It will be understood that, although the terms first, second, etc. may be used herein to describe various elements, these elements should not be limited by these terms since such terms are only used to distinguish one element from another. For example, a first element could be termed a second element, and, similarly, a second element could be termed a first element, without departing from the scope of example embodiments. As used herein, the term “and” is used in both the conjunctive and disjunctive sense and includes any and all combinations of one or more of the associated listed items. The singular forms “a”, “an” and “the” are intended to include the plural forms as well, unless the context clearly indicates otherwise. It will be further understood that the terms “comprises”, “comprising,”, “includes” and “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

In the following description, for purposes of explanation and not limitation, specific details are set forth such as particular architectures, interfaces, techniques, etc., in order to provide a thorough understanding of illustrative embodiments of the invention. However, it will be apparent to those skilled in the art that the invention may be practiced in other illustrative embodiments that depart from these specific details. In some instances, detailed descriptions of well-known systems, devices, circuits, and methods are omitted so as not to obscure the description of described embodiments with unnecessary detail. All principles, aspects, and embodiments, as well as specific examples thereof, are intended to encompass both structural and functional equivalents thereof. Additionally, it is intended that such equivalents include both currently known equivalents as well as equivalents developed in the future.

While the disclosed invention is illustratively described in terms of a wireless system proving service according to the LTE standards, and the E-UTRAN air interface standard associated with such LTE wireless systems, it should be readily apparent that the inventive concept is applicable to other wireless configurations in which access to the wireless infrastructure from a mobile unit is initiated via a contention based, common transport channel having a plurality of defined access preambles.

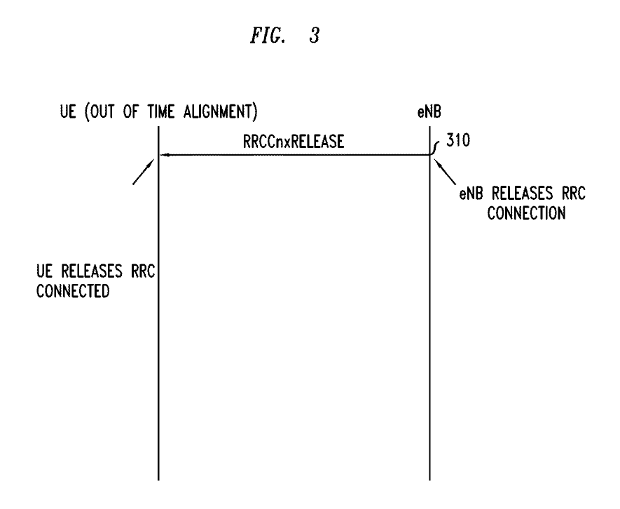

FIG. 3 illustrates a schematic depiction of an example message call flow for a UE resulting in the release of an Out-of-Time-Alignment UE in RRC_Connected State in accord with the principles of the invention. The term “wireless access device”, “user equipment”, “user device”, “user”, “mobile” or “mobile node” refers to electronic devices having wireless communication capabilities, such as, a cellular phone, personal digital assistant (PDA), smartphone, laptop computer, etc. More generally, these terms refers to any electronic device capable of changing its point of attachment from one network or subnetwork to another.

If an eNB knows a UE is in out-of-time-alignment state, and the eNB intends to release the RRC connection, the eNB directly issues a message to the UE instructing the release of the RRC connection (e.g., a RRC Connection Release message (i.e., RRCCnxRelease)). In step 310, the eNB sends RRC Connection Release message and releases the RRC connection.

Since the UE is still monitoring the DL, the UE is able to detect and decode the packet, although without transmitting Hybrid-Automatic-Repeat-Request Acknowledge (HARQ ACK) on the UL. Accordingly, the radio resource control connection release message may include an indicator which serves to instruct the wireless access device that the radio resource control connection release message is not be responded to. Due to lack of ACK reception in reply, the eNB may retransmit the RRC Connection Release message multiple times for robustness. On the other end of the transmission, once the UE receives the RRC Connection Release message, UE is able to process the message from Layer 1 (L1) to the RRC layer and reacts by releasing the connection. Existing Third Generation Partnership Project (3GPP) standards allow a UE to react to the RRC release message without sending a Radio Link Control layer (RLC-layer) acknowledgement to eNB. This behavior further facilitates the solution.

Embodiments of the invention allows fast connection release of out-of-time-alignment users by eNB without incurring the RF and signaling overhead that requires putting UE back to UL time alignment first before connection release. In this manner, the embodiments provided herein avoid all the RACH/RRC level overhead associated with recovering a UE's UL time alignment and reallocating the UE's UL control channel resource when the eNB tries to release an out-of-time-alignment UE who status the eNB knows. In this way, the signaling overhead associated with pushing an out-of-time-alignment UE to RRC IDLE is much reduced.

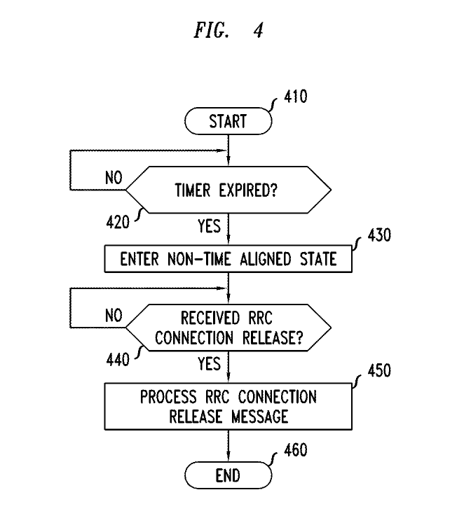

FIG. 4 illustrates an example flow diagram illustrating activity at a UE in accord with the principles of the invention.

At step 410, the method begins.

At step 420, the wireless access device (e.g., smartphone) determines whether a time alignment timer has expired. If the time alignment timer has not expired, the method returns to once again check for time alignment timer expiration. While waiting for expire of the time alignment timer, the wireless access device may perform other functions. The wireless access device may be one of a user equipment, a mobile, mobile device, a mobile station, an electronic device having wireless communication capabilities, a cellular phone, a personal digital assistant (PDA), a smartphone, a laptop computer or an electronic device capable of changing its point of attachment from one network or subnetwork to another.

At step 430, in response to the expiry of the time alignment timer, the wireless access device is configured to enter a non-time aligned state. The wireless access device releases layer 1 UL control channel resource in response to entry into the non-time aligned state. Thus, the non-time aligned stated characterized by a lack of up link channel control by the wireless access device. The wireless access device configured to receive a radio resource control connection release message while in a non-time aligned state. While in the non-time aligned state, the wireless access device is still able to monitor the DL.

At step 440, while in the non-time aligned state, the wireless access device determines whether a radio resource control connection release message is received. The non-time aligned state is characterized by a lack of up link channel control by the wireless access device. If radio resource control connection release message is received, the method returns to once again check for receipt radio resource control connection release message. During this period of time while waiting for a radio resource control connection release message, the wireless access device may process other messages and/or perform other functions.

At step 450, the wireless access device processes the radio resource control connection release message in response its receipt. At this time, the wireless access device is in the non-time aligned state. The processing of the radio resource control connection release message includes the wireless access device releasing the radio resource control connection. This processing may include entering the wireless access device into an idle state in response to receipt of the radio resource control connection release message while in the non-time aligned state.

At step 460, the method ends.

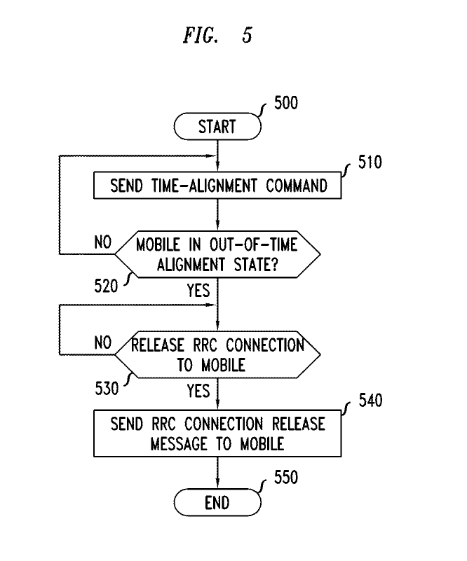

FIG. 5 illustrates an example flow diagram illustrating activity at an eNB in accord with the principles of the invention.

At step 500, the method begins.

At step 510, the wireless access point (e.g., eNb) sends a time alignment command to a mobile device 21. The wireless access point may be a base station, a Node B, and enhanced Node B.

At step 520, the wireless access point determines whether the mobile device is in an out of time alignment state (i.e., a non-time aligned state). The wireless access point determines that the mobile device is in the non-time aligned state based on passage of a period of time with a lack of data channel traffic with the wireless access device. That is; a period of time (e.g., a second period of time) passes without data communication (transmission or reception of data channel traffic) with the mobile device. Thus, the non-time aligned state is characterized by a lack of data channel traffic with the wireless access device. When a mobile is in the non-time aligned state, it is not sent time alignment command messages. If the mobile is not in the out of time alignment state, the method returns to once again send a time alignment command to the mobile at step 510. If the mobile is in the out of time alignment state, the method proceeds to step 530.

At step 530, the wireless access point determines whether the RRC connection to the mobile should be released. The wireless access point determines that RRC connection to the mobile should be released based on passage of a period of time with a lack of data channel traffic with the wireless access device. That is; a period of time (e.g., a first period of time) passes without data communication (transmission or reception of data channel traffic) with the mobile device. If the RRC connection to the mobile should not be released, the method returns to once again determine whether the RRC connection to the mobile should be released at step 530. If the RRC connection to the mobile should be released, the method proceeds to step 540.

At step 540, in response having determined both that the mobile is in an out of time alignment state and that the RRC connection to the mobile should be release, the wireless access device sends a RRC connection release message to the mobile. Note that the period time that passes without data communication which is utilized in order to determine that the RRC connection to the mobile should be released is longer than the period time that passes without data communication which is utilized to determine that the mobile has entered an out of time alignment state.

At step 550, the method ends.

In one example embodiment, the method implemented by the eNb includes determining whether a wireless access device is in a non-time aligned state, determining whether a radio resource control connection to the wireless access device should be released, and instructing transmission of at least one radio resource control connection release message to the wireless access device for releasing a radio resource control connection when determining both that the wireless access device is in a non-time aligned state and a radio resource control connection to the wireless access device should be released, the transmission of the at least one radio resource control connection release message performed without first instructing transmission of control messages for enabling the wireless access device to regain layer 1 control channel resource.

The method functions described above are readily carried out by special or general purpose digital information processing devices acting under appropriate instructions embodied, e.g., in software, firmware, or hardware programming. For example, functional modules of the DSP and the other logic circuits can be implemented as an ASIC (Application Specific Integrated Circuit) constructed with semiconductor technology. Alternatively, various modules may be implemented with FPGA (Field Programmable Gate Arrays) and other hardware blocks. As such, the process steps described herein are intended to be broadly interpreted as being equivalently performed by software, hardware and a combination thereof in various alternative embodiments.

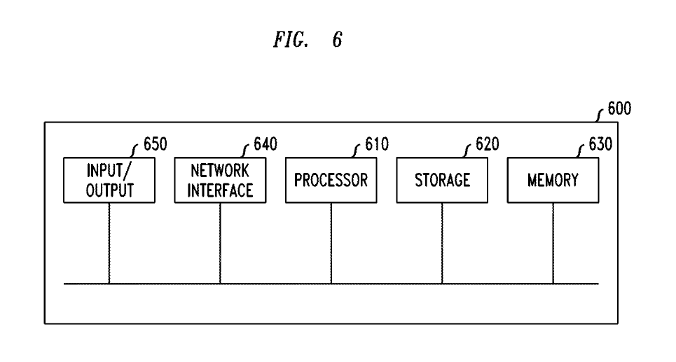

The above-described methods may be implemented on a computer using well-known computer processors, memory units, storage devices, computer software, and other components. FIG. 6 illustrates a high-level block diagram of an example computer for implementing a UE or eNB in accord with the principles of the invention. Computer 600 contains a processor 610, which controls the overall operation of the computer 600 by executing computer program instructions which define such operation. The computer program instructions may be stored in a storage device 620 (e.g., magnetic disk) and loaded into memory 630 when execution of the computer program instructions is desired. Thus, the steps of the method of FIGS. 4 and 5 may be defined by the computer program instructions stored in the memory 630 and/or storage 620 and controlled by the processor 610 executing the computer program instructions.

The computer 600 may include one or more network interfaces 640 for communicating with other devices via a network for implementing the steps of the method. The computer 600 may also include other input/output devices 650 that enable user interaction with the computer 600 (e.g., display, keyboard, mouse, speakers, buttons, etc.). One skilled in the art will recognize that an implementation of an actual computer could contain other components as well, and that FIG. 6 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A wireless communication system comprising:
a wireless access device, the wireless access device configured to receive a radio resource control connection release message while in a non-time aligned state, the non-time aligned state characterized by a lack of up link channel control by the wireless access device; and
a wireless access point, the wireless access point configured to transmit the radio resource control connection release message when the wireless access point determines that a radio resource control connection to the wireless access device should he released and the wireless access device is in the non-time aligned state.

2. The wireless communication system of claim 1 wherein the wireless access device is configured to enter the non-time aligned state in response to the expiry of a time alignment timer.

3. The wireless communication system of claim 2 wherein the wireless access device is configured to release layer 1 control channel resource in response to entry into the non-time aligned state.

4. The wireless communication system of claim 1 wherein the wireless access device is configured to release the radio resource control connection in response to receipt of the radio resource control connection release message while in the non-time aligned state.

5. The wireless communication system of claim 1 wherein the wireless access device is configured to enter an idle state in response to receipt of the radio resource control connection release message while in the non-time aligned state.

6. The wireless communication system of claim 1 wherein the wireless access device is a user equipment and wherein the wireless access point is a base station, a Node B, and enhanced Node B.

7. The wireless communication system of claim 1 wherein the wireless access point is configured to determine that the radio resource control connection to the wireless access device should be released based on passage of a first period of time without data channel traffic with the wireless access device.

8. The wireless communication system of claim 7 wherein the wireless access point is configured to determine that the wireless access device is in the non-time aligned state based on passage of a second period of time with a lack of data channel traffic with the wireless access device, and wherein the first period of time is greater than the second period of time.

9. The wireless communication system of claim 1 wherein the wireless access point is configured to determine that the wireless access device is in the non-time aligned state based on passage of a second period of time without data channel traffic with the wireless access device.

10. The wireless communication system of claim 1 wherein the wireless access point is configured to end or preclude transmission of time alignment messages to the wireless device when the wireless access point determines the wireless access device is in the non-time aligned state.

11. An apparatus comprising:
a processor and an associated memory, wherein the processor is configured to receive a radio resource control connection release message while in a non-time aligned state, the non-time aligned stated characterized by a lack of up link channel control by the apparatus.

12. The apparatus of claim 11 wherein the processor is configured to enter the non-time aligned state and release layer 1 control channel resource in response to expiry of a time alignment timer.

13. The apparatus of claim 11 wherein the processor is configured to release the radio resource control connection in response to receipt of the radio resource control connection release message while in the non-time aligned state.

14. The apparatus of claim 11 wherein the processor is configured to enter an idle state in response to receipt of the radio resource control connection release message while in the non-time aligned state.

15. The apparatus of claim 11 wherein the apparatus is a user equipment, a mobile, mobile device, a mobile station, an electronic device having wireless communication capabilities, a cellular phone, a personal digital assistant (PDA), a smartphone, a laptop computer or an electronic device capable of changing its point of attachment from one network or subnetwork to another.

16. An apparatus comprising:
a processor and an associated memory, wherein the processor is configured to transmit a radio resource control connection release message in response to determining that a radio resource control connection to a wireless access device should be released and the wireless access device is in a non-time aligned state, the non-time aligned state characterized by a lack of data channel traffic with the wireless access device.

17. The apparatus of claim 16 wherein the processor is configured to determine that the radio resource control connection to the wireless access device should be released based on passage of a first period of time without data channel traffic with the wireless access device.

18. The apparatus of claim 17 wherein the processor is configured to determine that the wireless access device is in the non-time aligned state based on passage of a second period of time with a lack of data channel traffic with the wireless access device.

19. The apparatus of claim 18 wherein the first period of time is greater than the second period of time.

20. The apparatus of claim 16 wherein the processor is configured to end or preclude transmission of time alignment messages for the wireless access device when the processor determines that the wireless access device is in the non-time aligned state.

21. The apparatus of claim 16 wherein the apparatus is a base station, a Node B, and enhanced Node B.

22. The apparatus of claim 16 wherein the radio resource control connection release message includes an indicator for instructing the wireless access device that the radio resource control connection release message is not to be responded to.

23. A management element for a wireless communication system, the management element comprising a processor configured for
determining whether a wireless access device is in a non-time aligned state;
determining whether a radio resource control connection to the wireless access device should be released; and
instructing transmission of at least one radio resource control connection release message to the wireless access device for releasing a radio resource control connection when determining both that the wireless access device is in a non-time aligned state and a radio resource control connection to the wireless access device should be released, the transmission of the at least one radio resource control connection release message performed without first instructing transmission of control messages for enabling the wireless access device to regain layer 1 control channel resource.
